(19) United States
(12) Patent Application Publication
(10) Pub. No.: US 2025/0276541 A1
(43) Pub. Date: Sep. 4, 2025

(54) POP-UP PAGE MARKING TOOL

(71) Applicant: LOVEPOP, INC., Boston, MA (US)

(72) Inventors: Trung Nguyen Nhat, Buon Ma Thuoc (VN); Uyen Duong Thao, Trieu Phong (VN); Tin Nguyen Trung, Phu Ninh (VN); Nhi Vo Trieu Tuyet, Hai Lang (VN)

(21) Appl. No.: 19/069,842

(22) Filed: Mar. 4, 2025

Related U.S. Application Data
(60) Provisional application No. 63/560,954, filed on Mar. 4, 2024.

(51) Int. Cl. B42D 9/00

(52) U.S. Cl. CPC B42D 9/007

(57) ABSTRACT

Implementations described and claimed herein provide a pop-up page marking tool. In one implementation, the pop-up page marking tool includes a body configured to be disposed in a print media and a decorative portion coupled to the body. The body is configured to change the pop-up page marking tool between a folded configuration and a pop-up configuration in response to movement of the body.

### CROSS-REFERENCE TO RELATED APPLICATIONS

The present application claims priority to U.S. Provisional Patent Application No. 63/560,954 filed on Mar. 4, 2024, which is incorporated by reference in its entirety herein.

### FIELD

The present application relates generally to marking tools and, more particularly, to a marking tool used for indicating a reader's progress in a printed media.

### BACKGROUND

Marking tools, such as, for example, bookmarks, typically include a single, flat body with a message and/or illustrations disposed thereon. However, the single, flat body may not provide enough space to fully convey the message that the giver intends to send to the recipient of the card. Moreover, the single, flat body may easily fall out of the printed media, thereby losing the reader's progress. It is with these observations in mind, among others, that various aspects of the present disclosure were conceived and developed.

### SUMMARY

Implementations described and claimed herein address the foregoing problems by providing a pop-up page marking tool that includes a three-dimensional pop-up structure, while maintaining a compact profile to fit in, for example, between sheets of a printed media, such as, for example, a book. In one implementation, the page marking tool includes a body including a fold line allowing the ends of the body to be positioned relative to each other to selectively put the page marking tool in a pop-up configuration or a folded configuration. The folded configuration allows the page marking tool to have a compact profile to fit in, for example, between sheets of a printed media, such as, for example, a book. In the pop-up configuration, the three dimensional pop-up structure is in an erected state.

In an implementation, a pop-up page marking tool comprises a body moveable along one or more fold lines between a first position and a second position, and a decorative portion coupled to the body. The decorative portion in a flattened state when the body is in the first position, and the decorative portion is an erected three dimensional state when the body is in the second position.

In another implementation, a method for operating a pop-up page marking tool includes moving a body of the pop-up page marking tool from a first position to a second position, the body including one or more fold lines, transitioning a decorative portion coupled to the body to an erected three dimensional state when the body is in the second position, moving the body from the second position to the first position, and transitioning the decorative portion from the erected three dimensional state to a flattened state.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows a perspective view of an example pop-up page marking tool in a pop-up configuration.

FIG. 2 shows a perspective view the pop-up page marking tool of FIG. 1 in a folded configuration.

FIG. 3 shows a perspective view of the pop-up page marking tool of FIG. 1 disposed in an example printed media.

FIG. 4 shows a top view of the pop-up page marking tool of FIG. 1 disposed in an example printed media.

FIG. 5 shows a perspective view of another example pop-up page marking tool in a pop-up configuration.

FIG. 6 shows a perspective view of another example pop-up page marking tool in a pop-up configuration.

FIG. 7 shows a perspective view of the pop-up page marking tool of FIG. 6 disposed in an example printed media.

FIG. 8 shows a top view of the pop-up page marking tool of FIG. 6 disposed in an example printed media.

FIG. 9 shows a perspective view the pop-up page marking tool of FIG. 6 in a folded configuration.

FIG. 10 shows a perspective view of an example pop-up page marking tool in a pop-up configuration disposed in an example printed media.

FIG. 11 shows another perspective view of the pop-up page marking tool of FIG. 10.

FIG. 12 shows a first side view of the pop-up page marking tool of FIG. 10 in a folded configuration.

FIG. 13 shows a second side view of the pop-up page marking tool of FIG. 10 in a folded configuration.

FIG. 14 shows a top view of the pop-up page marking tool of FIG. 10 disposed in an example printed media in the folded configuration.

FIG. 15 shows a top view of the pop-up page marking tool of FIG. 10 disposed in an example printed media in a pop-up configuration.

FIG. 16 shows a perspective view of an example pop-up page marking tool in a pop-up configuration.

FIG. 17 shows a perspective view the pop-up page marking tool of FIG. 16 in a folded configuration.

FIG. 18 shows a top view of the pop-up page marking tool of FIG. 16.

FIG. 19 shows a bottom view of the pop-up page marking tool of FIG. 16.

FIG. 20 shows a top view of the pop-up page marking tool of FIG. 16 disposed in an example printed media in the folded configuration.

### DETAILED DESCRIPTION

Aspects of the presently disclosed technology relate to a page marking tool. In one implementation, the page marking tool includes a body having a fold line that allows respective ends of the body to be positioned relative to each other to selectively put the page marking tool in a pop-up configuration or a folded configuration. The page marking tool allows for various pop-up messages and illustrations, such as, for example, three-dimensional pop-up structure, to be displayed while still having a compact profile to fit in, for example, between sheets of a printed media, such as, for example, a book, when disposed in the folded configuration. As illustrated in the Figures, the page marking tool may further include various ornamental features.

The technology disclosed herein generally provides for marking tools. The example implementations discussed and illustrated herein reference a page marking tool. However, it will be appreciated by those skilled in the art that the presently disclosed technology is applicable to other types of structures, including, but not limited to, posters, books, holiday cards, greeting cards, and/or the like. It will be appreciated that various configurations are contemplated.

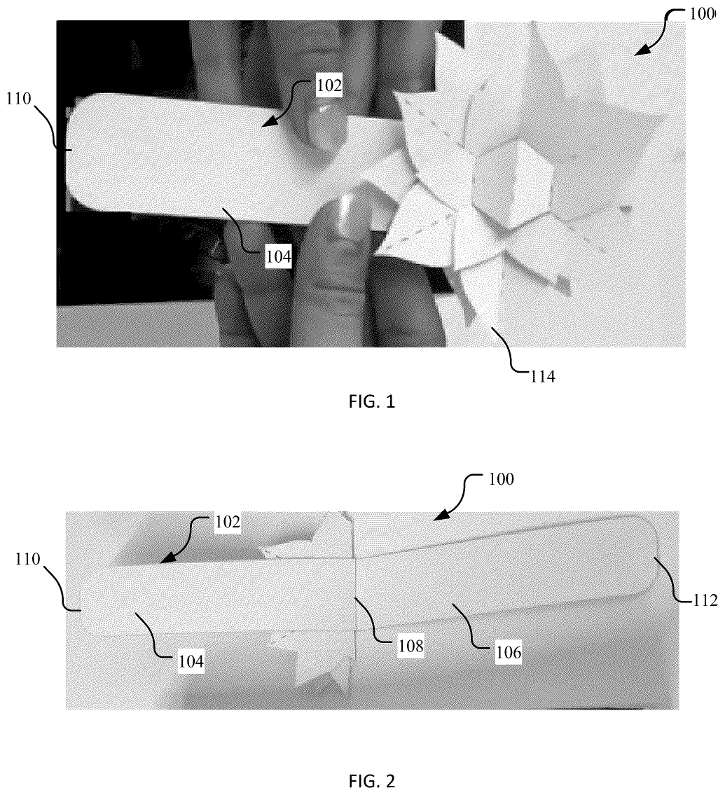

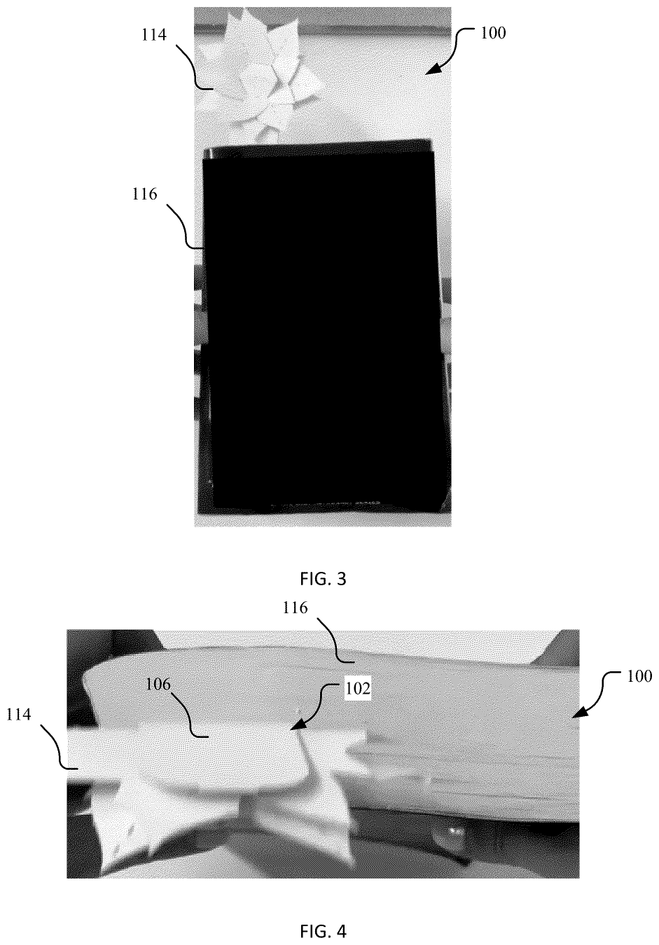

To begin a detailed description of a pop-up page marking tool 100, reference is made to FIGS. 1-4. In one implementation, the pop-up page marking tool 100 includes a body 102. The body 102 is divided into a first body portion 104 and a second body portion 106 by a fold line 108. The fold line 108 allows the first body portion 104 to rotate relative to the second body portion 106. The body 102 further includes a first end 110 disposed on the first body portion 104 and a second end 112 disposed on the second body portion 106. Although only one fold line 108 is illustrated, the present disclosure is not limited to one fold line and any number of fold lines can be used.

In an implementation, the pop-up page marking tool 100 includes a decorative portion 114. The decorative portion 114 is mounted to the first body portion 104 and the second body portion 106. In an implementation, the decorative portion 114 is an erectable pop-up display structure comprising a plurality of intersecting slice-form elements. In this implementation, when the pop-up page marking tool 100 is in a folded configuration, the decorative portion 114 is in a flattened state and the first end 110, the first body portion 104, the second body portion 106 and the second end 112 are in a same plane (FIG. 2). When the pop-up page marking tool 100 is in a pop-up configuration, the decorative portion 114 is in an erected three dimensional state (FIGS. 1, 3, and 4). The pop-up page marking tool 100 is converted between the folded configuration and the pop-up configuration by rotating the first body portion 104 and the first end 110 about the fold line 108 relative to the second body portion 106 and the second end 112.

When in the pop-up configuration, the first body portion 104 and the second body portion 106 can be positioned between pages of a printed media 116, such as, for example, a book, thereby saving progress of a reader. In this configuration, the decorative portion 114 can restrict the pop-up page marking tool 100 from moving relative to the printed media 116 when the printed media 116 is in an upright orientation, such as when placed on a shelf.

Although the decorative portion 114 is illustrated as a flower, the disclosure is not limited as such, and the decorative portion 114 can include various decorative features, such as, for example, imitation flowers, imitation leaves, imitation trees, imitation plants, characters, animals, insects, objects, and/or the like. Referring to FIG. 5, another implementation of a pop-up page marking tool 200 is shown. The pop-up page marking tool 200 is substantially the same as the pop-up page marking tool 100, except the decorative portion 214 being a floral feature.

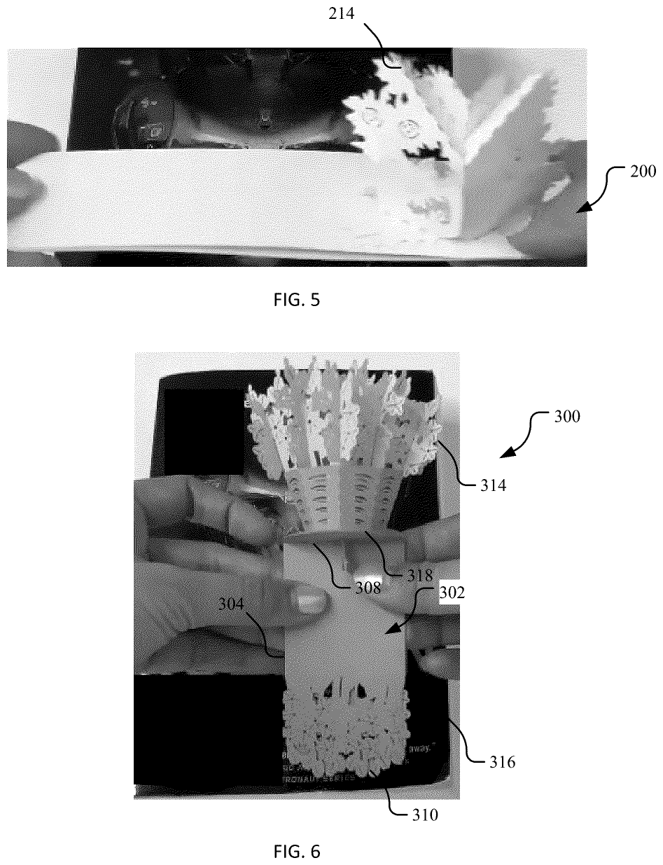

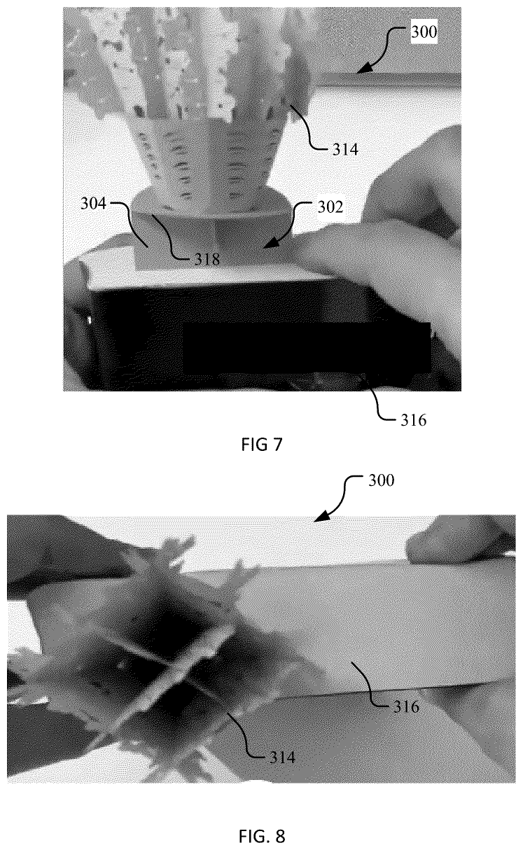

Referring to FIGS. 6-9, another implementation of a pop-up page marking tool 300 is shown. In one implementation, the pop-up page marking tool 300 includes a body 302. The body 302 is divided into a first body portion 304 and a second body portion 306 by a fold line 308. The fold line 308 allows the first body portion 304 to rotate relative to the second body portion 306. The body 302 further includes a first end 310 disposed on the first body portion 304 and a second end 312 disposed on the second body portion 306. Although only one fold line 308 is illustrated, the present disclosure is not limited to one fold line and any number of fold lines can be used.

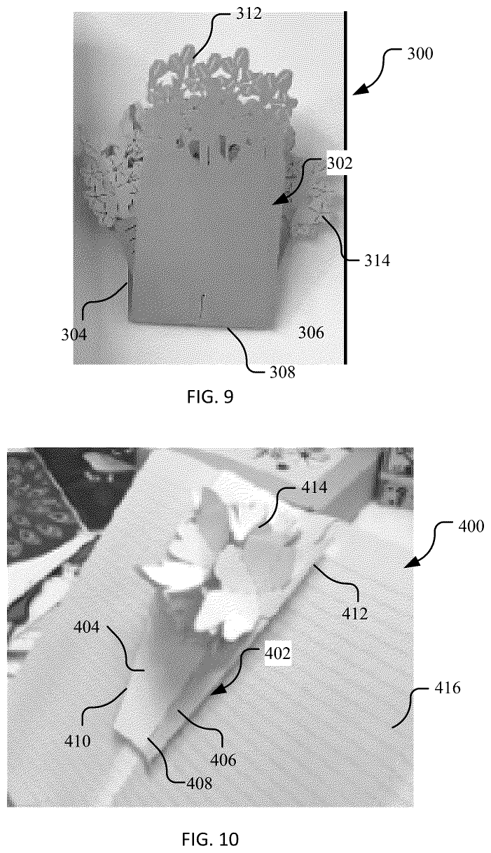

In an implementation, the pop-up page marking tool 300 includes a decorative portion 314. The decorative portion 314 is mounted to the body 302 at the fold line 308 via a base 318. In an implementation, the decorative portion 314 is an erectable pop-up display structure comprising a plurality of intersecting slice-form elements. In this implementation, when the pop-up page marking tool 300 is in a folded configuration, the decorative portion 314 is in a flattened state and the first end 310 and the second end 312 are adjacent to one another (FIG. 9). When the pop-up page marking tool 300 is in a pop-up configuration, the decorative portion 314 is in an erected three dimensional state and the first end 310 and the second end 312 are adjacent to one another (FIGS. 6-8). The pop-up page marking tool 300 is converted between the folded configuration and the pop-up configuration by rotating the first body portion 304 and the first end 310 about the fold line 308 relative to the second body portion 306 and the second end 312.

When in the pop-up configuration, the first body portion 304 and the second body portion 306 can be positioned between pages of a printed media 316, such as, for example, a book, thereby saving progress of a reader. In this configuration, the decorative portion 314 can restrict the pop-up page marking tool 300 from moving relative to the printed media 316 when the printed media 316 is in an upright orientation, such as when placed on a shelf.

Although the decorative portion 314 is illustrated as a basket of flowers, the disclosure is not limited as such, and the decorative portion 314 can include various decorative features, such as, for example, imitation flowers, imitation leaves, imitation trees, imitation plants, characters, animals, insects, objects, and/or the like.

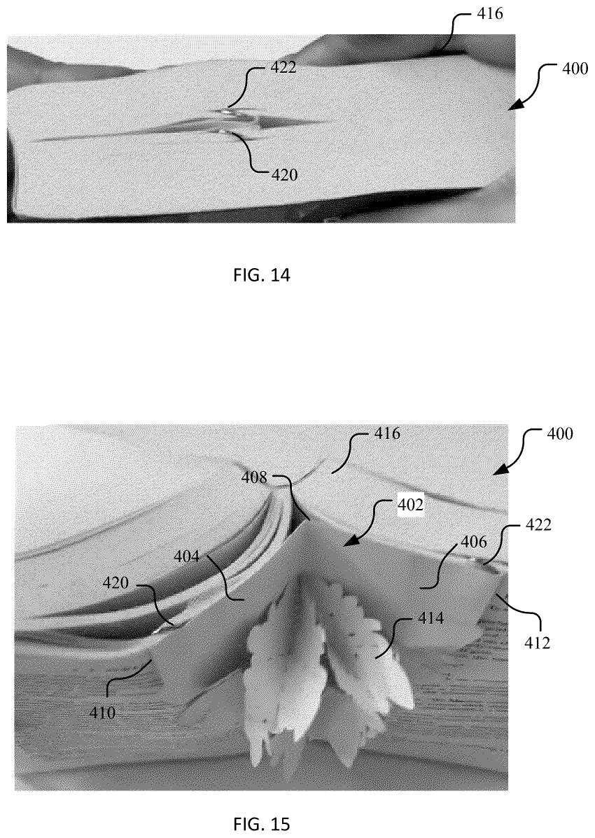

Referring to FIGS. 10-15, another implementation of a pop-up page marking tool 400 is shown. In one implementation, the pop-up page marking tool 400 includes a body 402. The body 402 is divided into a first body portion 404 and a second body portion 406 by a fold line 408. The fold line 408 allows the first body portion 404 to rotate relative to the second body portion 406. The body 402 further includes a first end 410 disposed on the first body portion 404 and a second end 412 disposed on the second body portion 406. Although only one fold line 408 is illustrated, the present disclosure is not limited to one fold line and any number of fold lines can be used.

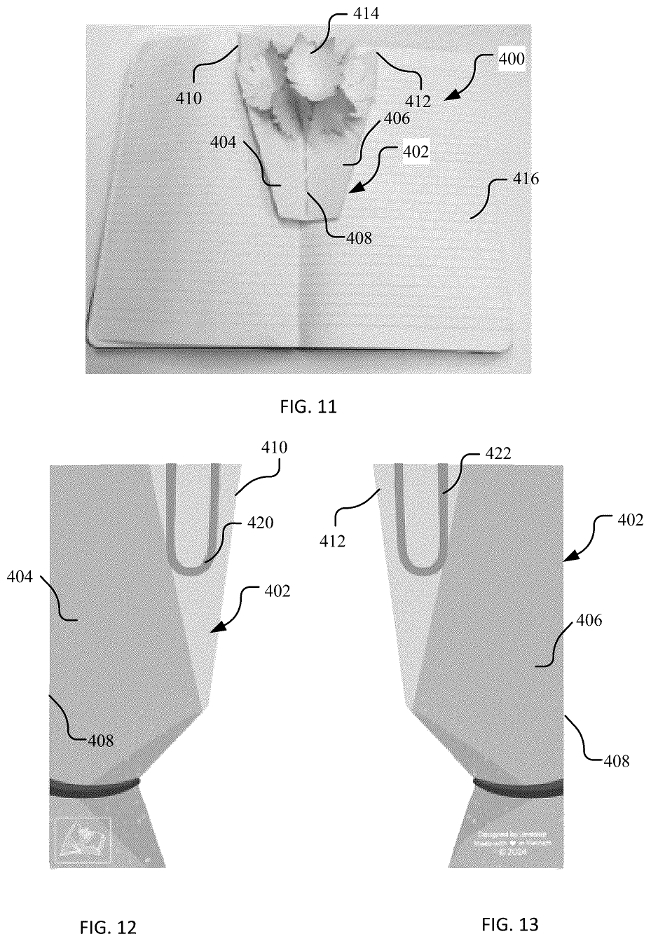

In an implementation, the pop-up page marking tool 400 includes a decorative portion 414. The decorative portion 414 is mounted to the body 402 at the first body portion 404 and the second body portion 406. In an implementation, the decorative portion 414 is an erectable pop-up display structure comprising a plurality of intersecting slice-form elements. In this implementation, when the pop-up page marking tool 400 is in a folded configuration, the decorative portion 414 is in a flattened state, the first end 410 and the second end 412 are adjacent to one another, and the first body portion 404 and the second body portion 406 are adjacent to one another (FIGS. 12, 13, and 14). When the pop-up page marking tool 400 is in a pop-up configuration, the decorative portion 414 is in an erected three dimensional state, the first end 410 and the second end 412 are spaced from each other, and the first body portion 404 and the second body portion 406 are spaced from each other (FIGS. 10, 11, and 15). The pop-up page marking tool 400 is converted between the folded configuration and the pop-up configuration by rotating the first body portion 404 and the first end 410 about the fold line 408 relative to the second body portion 406 and the second end 412.

The first body portion 404 and the second body portion 406 can be positioned between pages of a printed media 416, such as, for example, a book, thereby saving progress of a reader. In an implementation, a first engaging member 420 is coupled to the first body portion 404, and a second engaging member 422 is coupled to the second body portion 406. The first engaging member 420 and the second engaging member 422 are configured to engage one or more sheets of the printed media 416, such as, for example, pages of a book. In this implementation, the first engaging member 420 and the second engaging member 422 can restrict the pop-up page marking tool 400 from moving relative to the printed media 416. Additionally, when the printed media 416 is moved between opened and closed positions, the pop-up page marking tool 400 is cooperatively converted between the folded configuration and the pop-up configuration.

In an implementation, the first engaging member 420 and the second engaging member 422 are composed of a different material than the first body portion 404 and the second body portion 406, such as for example, metal. In an implementation, the first engaging member 420 and the second engaging member 422 are respectively a metal paper clip, a hook, an arm, and/or the like.

Although the decorative portion 414 is illustrated as flowers, the disclosure is not limited as such, and the decorative portion 414 can include various decorative features, such as, for example, imitation flowers, imitation leaves, imitation trees, imitation plants, characters, animals, insects, objects, and/or the like.

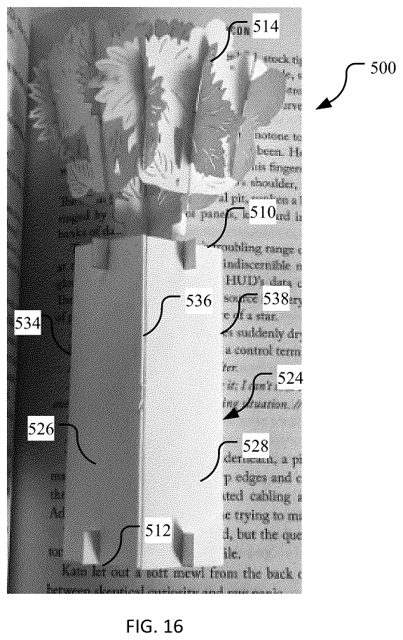

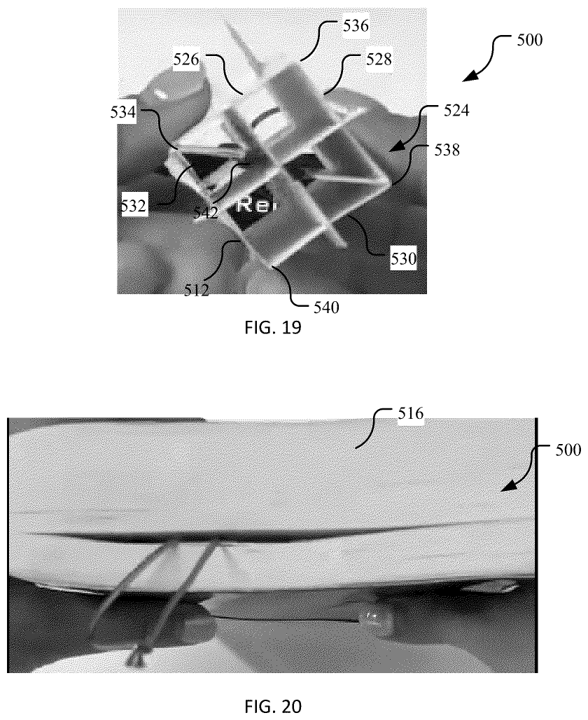

Referring to FIGS. 16-20, another implementation of a pop-up page marking tool 500 is shown. In one implementation, the pop-up page marking tool 500 includes a body 524. The body 524 includes a first side 526, a second side 528, a third side 530, and a fourth side 532. The first side 526 extends between a first edge 534 and a second edge 536. The second side 528 extends between the second edge 536 and a third edge 538. The third side 530 extends between the third edge 538 and the fourth edge 540. The fourth side 532 extends between the fourth edge 540 and the first edge 534. Thus, the first edge 534 rotatably couples the first side 526 to the fourth side 532 to allow the first side 526 and the fourth side 532 to rotate relative to one another. The second edge 536 rotatably couples the first side 526 to the second side 528 to allow the first side 526 and the second side 528 to rotate relative to one another. The third edge 538 rotatably couples the second side 528 to the third side 530 to allow the second side 528 and the third side 530 to rotate relative to one another. The fourth edge 540 rotatably couples the third side 530 to the fourth side 532 to allow the third side 530 and the fourth side 532 to rotate relative to one another. The body 524 further includes a first end 510 and a second end 512 disposed opposite the first end 510. In an implementation, the first edge 534, the second edge 536, the third edge 538, and the fourth edge 540 are fold lines. Although four sides and four edges are illustrated, the present disclosure is not limited as such and any suitable number of sides and edges can be used.

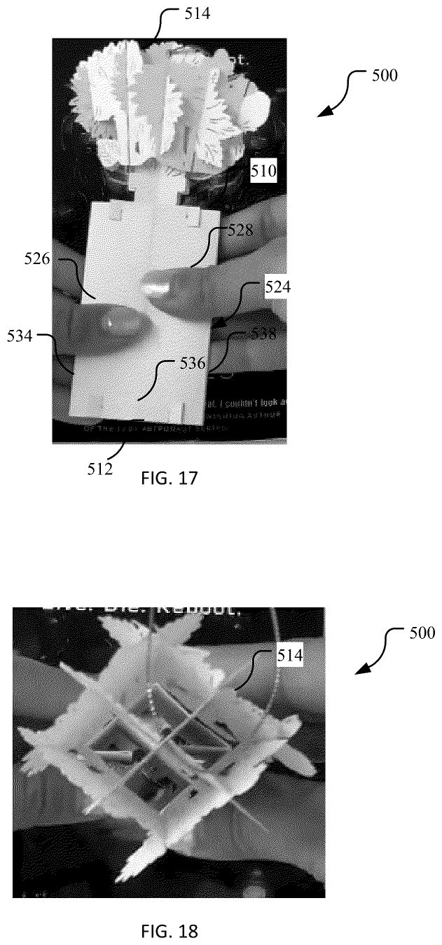

In an implementation, the pop-up page marking tool 500 includes a decorative portion 514. The decorative portion 514 is mounted to the body 524 at the first end 510. In an implementation, the decorative portion 514 is an erectable pop-up display structure comprising a plurality of intersecting slice-form elements. In this implementation, when the pop-up page marking tool 500 is in a folded configuration, the decorative portion 514 is in a flattened state, the first side 526 and the second side 528 are respectively adjacent to the third side 530 and the fourth side 532 (FIGS. 17 and 20). When the pop-up page marking tool 500 is in a pop-up configuration, the decorative portion 514 is in an erected three dimensional state, the first side 526 is parallel to the third side 530 and the second side 528 is parallel to the fourth side 532 (FIGS. 16, 18, and 19). The pop-up page marking tool 500 is converted from the pop-up configuration to the folded configuration by applying a force to at least one of the first side 526, the second side 528, the third side 530, or the fourth side 532.

In an implementation, the pop-up page marking tool 100 includes a biasing member 542 configured to bias the pop-up page marking tool 500 from the folded configuration to the pop-up configuration when the force is no longer applied to at least one of the first side 526, the second side 528, the third side 530, or the fourth side 532. In an implementation, the biasing member 542 is coupled to the first edge 534 and the third edge 538 and/or the second edge 536 and the fourth edge 540. In this implementation, the biasing member 542 applies a biasing force to the first edge 534 and the third edge 538 and/or the second edge 536 and the fourth edge 540 to bias the pop-up page marking tool 500 in the pop-up configuration. To change the pop-up page marking tool 500 from the pop-up configuration to the folded configuration, the force applied to at least one of the first side 526, the second side 528, the third side 530, or the fourth side 532 must overcome the biasing force of the biasing member 542. In an implementation, the biasing member 542 is at least one of a spring, an elastic band, etc.

The body 524 can be positioned between pages of a printed media 516, such as, for example, a book, thereby saving progress of a reader. In this implementation, the decorative portion 514 can restrict the pop-up page marking tool 500 from moving relative to the printed media 516 when the printed media 516 is in an upright orientation, such as when placed on a shelf. Additionally, when the printed media 516 is moved between opened and closed positions, the pop-up page marking tool 500 is cooperatively converted between the folded configuration and the pop-up configuration. For example, when the printed media 516 is moved from the opened position to the closed position, the printed media 516 applies force to at least one of the first side 526, the second side 528, the third side 530, or the fourth side 532 to overcome the biasing force of the biasing member 542 to change the pop-up page marking tool 500 from the pop-up configuration to the folded configuration. When the printed media 516 is moved from the closed position to the open position, the printed media 516 no longer applies force to at least one of the first side 526, the second side 528, the third side 530, or the fourth side 532, thereby allowing the biasing force of the biasing member 524 to return the pop-up page marking tool 500 from the folded configuration to the pop-up configuration.

Although the decorative portion 514 is illustrated as flowers, the disclosure is not limited as such, and the decorative portion 514 can include various decorative features, such as, for example, imitation flowers, imitation leaves, imitation trees, imitation plants, characters, animals, insects, objects, and/or the like.

In an implementation, a method for operating the pop-up page marking tool 100-500 disclosed herein includes moving the body of the pop-up page marking tool 100-500 from a first position to a second position, transitioning a decorative portion coupled to the body to an erected three dimensional state when the body is in the second position, moving the body from the second position to the first position, and transitioning the decorative portion from the erected three dimensional state to a flattened state.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A pop-up page marking tool:
a body including one or more fold lines, the body moveable along one or more fold lines between a first position and a second position; and
a decorative portion coupled to the body, the decorative portion in a flattened state when the body is in the first position, and the decorative portion is an erected three dimensional state when the body is in the second position.

2. The tool of claim 1, wherein the body includes a first body portion and a second body portion, the first body portion rotatable relative to the second body portion to move the body between the first position and the second position.

3. The tool of claim 2, wherein the decorative portion is coupled to the first body portion and the second body portion.

4. The tool of claim 2, wherein the decorative portion is in the flattened state when the first body portion and the second body portion are in a same plane.

5. The tool of claim 2, wherein the decorative portion is in the flattened state when a first end disposed on the first body portion and a second end disposed on the second body portion are adjacent to one another.

6. The tool of claim 5, wherein the decorative portion is in the erected three dimensional state when the first end and the second end are spaced from each other.

7. The tool of claim 2, further comprising:
a first engaging member coupled to the first body portion; and
a second engaging member coupled to the second body portion.

8. The tool of claim 7, wherein the first engaging member and the second engaging member are composed of a different material than the first body portion and the second body portion.

9. The tool of claim 7, wherein the first engaging member and the second engaging member are at least one of a clip, a hook, or an arm configured to engage one or more sheets of printed media.

10. The tool of claim 1, wherein the one or more fold lines include a first edge, a second edge, a third edge, and a fourth edge, and
wherein the body includes a first side extending between the first edge and the second edge, a second side extending between the second edge and the third edge, a third side extending between the third edge and the fourth edge, and fourth side extending between the fourth edge and the first edge.

11. The tool of claim 10, wherein when the decorative portion is in the flattened state, the first side is adjacent to the fourth side and the second side is adjacent to the third side, and when the decorative portion is in the erected three dimensional state, the first side is substantially parallel to the third side and the second side is substantially parallel to the fourth side.

12. The tool of claim 10, wherein the body is moved between the first position and the second position by applying a force to at least one of the first side, the second side, the third side, or the fourth side.

13. The tool of claim 10 further comprising:
a biasing member coupled to at least one of the first edge, the second edge, the third edge, or the fourth edge, the biasing member applying a bias force to bias the body in the second position.

14. The tool of claim 13, wherein the biasing member is a spring or an elastic band.

15. The tool of claim 1, wherein the decorative portion is an erectable pop-up display structure comprising a plurality of intersecting slice-form elements.

16. The tool of claim 1, wherein the decorative portion includes one or more decorative features.

17. The tool of claim 16, wherein the one or more decorative features include at least one of one or more imitation flowers, one or more imitation leaves, one or more imitation trees, one or more imitation plants, one or more characters, one or more animals, one or more insects, or one or more objects.

18. The tool of claim 1, wherein the decorative portion is a floral feature.

19. The tool of claim 1, wherein the decorative portion is a basket of one or more flowers.

20. A method for operating a pop-up page marking tool, the method comprising:
moving a body of the pop-up page marking tool from a first position to a second position, the body including one or more fold lines;
transitioning a decorative portion coupled to the body to an erected three dimensional state when the body is in the second position;
moving the body from the second position to the first position; and
transitioning the decorative portion from the erected three dimensional state to a flattened state.
